(19) United States
(12) Patent Application Publication
(10) Pub. No.: US 2003/0021890 A1
(43) Pub. Date: Jan. 30, 2003

(54) Process for making a fuel cell with cylindrical geometry

(75) Inventors: Didier Marsacq, Grenoble (FR); Jean-Yves Laurent, Claix (FR); Didier Bloch, Biviers (FR); Christine Nayoze, Fontaine (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: COMMISSARIAT A L'ENERGIE ATOMIQUE, PARIS (FR)

(21) Appl. No.: 10/200,182

(22) Filed: Jul. 23, 2002

(30) Foreign Application Priority Data
Jul. 24, 2001 (FR) 01 09849

(51) Int. Cl. B05D 5/12

(52) U.S. Cl. 427/115

(57) ABSTRACT

The invention relates to a process for production of an electrode-membrane-electrode assembly on a cylindrical substrate (1), characterized in that the electrode-membrane-electrode assembly is made by successively depositing an electrode layer (2, 3), a membrane layer (4) and an electrode layer (5, 6) around the said cylindrical substrate, the said substrate being composed of a material that can be totally or partially eliminated during an elimination step at the end of the said process.

The invention also relates to an electrode-membrane-electrode assembly obtained by the said process and a fuel cell comprising at least one such electrode-membrane-electrode assembly.

### TECHNICAL DOMAIN

This invention relates to a process for making a cylindrical fuel cell architecture, more particularly an electrode-membrane-electrode assembly.

The invention also relates to a cell comprising such an assembly.

In general, a fuel cell is composed of a combination of elementary cells (each elementary cell consisting of an electrode-membrane-electrode assembly) resulting from a stack of layers. These layers are composed of electrode layers and electrolyte layers (called membrane layers when the electrolyte is a solid polymer). Each electrode layer may itself be composed of three thin layers:

a diffusion layer, usually made of porous carbon used to carry the input current and act as a mechanical support for the electrode and enabling good distribution of reagents to the active layer;

an active layer, in which the electrochemical reaction takes place and is usually composed of a carbon powder supporting catalyst particles, all being impregnated with a conducting polymer, for example a protonic polymer in order to encourage the appearance of triple points.

a current collecting layer made of a metallic material to carry the current towards the outside circuit.

### STATE OF PRIOR ART

Several embodiments have been proposed in the past for fuel cells.

Medium power fuel cells, producing 10 to 50 kW per cell, are usually produced by the “filter-press” association of two-pole graphite or stainless steel plates and electrode-membrane-electrode assemblies obtained by pressing two fabric electrodes and a NAFION® protonic conducting membrane.

Low power fuel cells, producing 0.5 to 50 W per cell, are called micro-fuel cells and are made based on developments of architectures and processes frequently derived from microelectronic technologies. The difficulty lies in the assembly of the micro-electrode with the thin ionic conducting film. Furthermore, due to its small size, the electrode must have a high electronic conductivity, high permeability to gas and particularly to hydrogen in the case of a PEMFC architecture for hydrogen/air cells, a high permeability to gas and methanol in the case of a DMFC architecture for methanol/air cells, the ability to be formed in a thin layer on a small surface, and good thermomechanical strength. The micro-electrode must also have a sufficient area for the deposit of a catalyst in dispersed form.

A distinction is made in the literature between porous silicon based architectures on which a catalyst is deposited followed by a Nafion® membrane to form the electrode-membrane assembly. However, the performances of this type of device are limited by the bad cohesion of the different layers, thus creating a high interface resistance, and consequently a very low dispersion of the catalyst, the catalyst being finely divided, in order to obtain a strongly electronic conducting deposit.

Different laboratories have developed different technologies on non-porous silicon. A team at the Lawrence Livermore National Laboratory has produced a micro-fuel cell by depositing firstly a thin metallic layer of nickel acting as an electronic collector on a silicon substrate. The catalyst then the protonic conductor are then deposited on the nickel. The nickel is then perforated by chemical etching to create contact between the catalyst and the reducer, namely hydrogen or methanol depending on the fuel cell system being considered. This technique has a number of disadvantages, particularly related to the properties of nickel. Nickel is sensitive to corrosion phenomena created by the strongly acid nature of the protonic conductor. Furthermore, the catalyst is also only weakly dispersed at the perforated nickel layer, which has a low ability to entrain a homogeneous dispersion of the reducing agent on the catalyst. Finally, with this technology, the probability of the presence of triple points is low.

Patent application WO 97/11503 and U.S. Pat. No. 5,759,712 describe a fuel cell architecture based on the use of a micro-porous base impregnated with a protonic conductor as the central element of a micro-fuel cell system. The different materials necessary for formation of a fuel cell are then deposited on each side of this substrate using conventional vacuum deposition techniques. This invention has two main disadvantages, firstly the fragility of the polymer substrate particularly when it is treated by aggressive vacuum deposition techniques, and secondly poor electrochemical performances related particularly to the lack of active area, and also the fragility of the catalyst deposit made directly on proton exchanging membranes.

All these described architectures have the special feature that they are all flat and consequently cannot give a sufficiently large electrode surface area to supply portable electronic devices with energy.

With this objective, several non flat geometries are proposed in prior art.

U.S. Pat. Nos. 6,080,501, 6,007,932 and 6,001,500 describe a miniature cylindrical fuel cell architecture. This architecture is based on winding an electrode-membrane-electrode assembly conventionally used with a flat geometry around a metallic foam mandrel. However, the performances of this type of assembly are limited mainly for two reasons:

the electrode-membrane-electrode assembly, which is initially flat is not adapted to a cylindrical geometry, which means that it is almost impossible to restore anode-anode, cathode-cathode and membrane-membrane contacts after winding the flat electrode-membrane-electrode assembly;

current collectors are not in intimate contact with the anode and the cathode, thus generating excessively high interface resistances.

Another American team has developed a similar miniature tubular fuel cell concept. An electrode-membrane-electrode assembly is wound to form a cylinder that is then integrated into a metallic “cylinder-holder device that collects the electric current. However, this type of architecture is not suitable for portable electronic equipment mainly due to the resulting size, due to the use of the “cylinder-holder” system.

### DESCRIPTION OF THE INVENTION

The purpose of this invention is to overcome the above disadvantages by proposing a process for the preparation of an electrode-membrane-electrode assembly, to be used in the composition of a low or medium power membrane fuel cell in order to obtain a high electrode surface area in a small volume.

Another purpose of this invention is to propose a process capable of obtaining an electrode-membrane-electrode assembly with good electrical contacts, thus overcoming the disadvantages of prior art for a cylindrical type architecture and to obtain a reagents distribution area at the end of the said process.

Finally, another purpose of the invention is to supply compact electrode-membrane-electrode assemblies to be used in the composition of fuel cells in order to supply power to portable electronic equipment.

In order to achieve this, the purpose of the invention is a process for making an electrode-membrane-electrode assembly on a cylindrical substrate, characterized in that the electrode-membrane-electrode assembly is made by successive deposition of an electrode layer, a membrane layer and an electrode layer around the said cylindrical substrate, the said substrate being composed of a material that can be totally or partially eliminated during an elimination step at the end of the said process.

According to the invention, the cylindrical substrate may be made from an organic material. Preferably, in this case the cylindrical substrate is obtained by extrusion of a polymer or a mix of polymers. According to another embodiment of the invention, the substrate may be made from a mineral material.

At the end of the process, the said substrate according to the invention is partially or totally eliminated by a chemical treatment or a heat treatment appropriate for the composition of the substrate.

According to the invention, the chemical treatment may also be intended to treat the membrane in order to prepare it for ionic conduction.

In other words, this chemical treatment intended to fully or partially eliminate the cylindrical substrate may also make the membrane conducting, in other words by transforming initially non conducting groups of this membrane into an ionic group capable of achieving ionic conduction (for example conduction of protons in the case of hydrogen cells).

According to the invention, the deposition of electrode layers may include the deposition of a diffusion layer preferably by the deposition of a porous material, the said material preferably being impregnated with a water repellent polymer.

According to the invention, the porous material partly forming the diffusion layer is preferably made of graphite.

The deposition of electrode layers advantageously includes the deposition of an active layer preferably made by depositing a catalyst layer on the said diffusion layer, the said catalyst preferably being in the form of noble metal grains (in other words grains of a metal chosen from among platinum, palladium, silver, gold). This active layer may then advantageously be impregnated with a conducting polymer, for example a protonic polymer with a structure identical to the membrane. Preferably, the noble metal used is platinum.

According to the invention, the deposition of the membrane layer, the said membrane being inserted between the electrodes, is achieved by deposition of a conducting polymer, for example protonic, or that could become a conducting polymer following an appropriate treatment.

Furthermore, the process for making an electrode-membrane-electrode assembly according to the invention may include a step to deposit a current collector at each electrode layer. According to a first embodiment of the invention, this deposition is made by a metallic deposition, preferably in spiral at each of the electrode layers. According to a second embodiment of the invention, the current collector is put into place by winding metallic micro-filaments around each electrode layer. Finally, according to a third embodiment, this metallic deposition may be made by a metallic fabric mesh at each electrode layer.

Another purpose of the invention is the electrode-membrane-electrode assembly obtained by the process comprising the previously mentioned characteristics.

The invention also relates to a fuel cell comprising at least one electrode-membrane-electrode assembly obtained by the same process.

This process has the advantage that it can be used to make compact electrode-membrane-electrode assemblies. Therefore, this type of architecture is suitable for the power supply of portable electronic appliances, due to the space saving generated by the compact electrode-membrane-electrode assemblies derived from the process.

Another advantage is due to the fact that this process uses a cylindrical support that can be partially or completely eliminated, that is made porous or is completely eliminated at the end of the process. This porosity or this empty space (depending on whether elimination is partial or total) is a means of creating a chamber for distribution of reagents in order to supply reagents to the electrode deposited directly on the substrate. Thus, for a PEMFC (“Proton Exchange Membrane Fuel Cell”) type of cell, the porosity or the empty space created by the final treatment of the cylindrical substrate will be used, for example, to supply hydrogen to the anode.

Another advantage is the ease with which this process is implemented, which simply requires the use of conventional deposition techniques, for example such as sputtering or dipping.

Other characteristics and advantages of the invention will be given in the following description, which is not limitative.

### BRIEF DESCRIPTION OF THE DRAWINGS

This description will be made with reference to the attached drawings in which:

FIG. 1 diagrammatically shows the sequence of layers deposited on the cylindrical substrate, the said sequence of layers thus forming an electrode-membrane-electrode assembly, and

FIG. 2 shows a diagrammatic view of an association of several electrode-membrane-electrode assemblies, obtained with the process according to the invention, these assemblies being arranged in series in order to form a portable fuel cell.

### DETAILED DESCRIPTION OF THE INVENTION

According to the invention, the electrode-membrane-electrode assembly is made by successive deposition of an electrode layer, then a membrane layer finally followed by an electrode layer at a cylindrical substrate, the said substrate being partially or completely eliminated by an appropriate treatment at the end of the process.

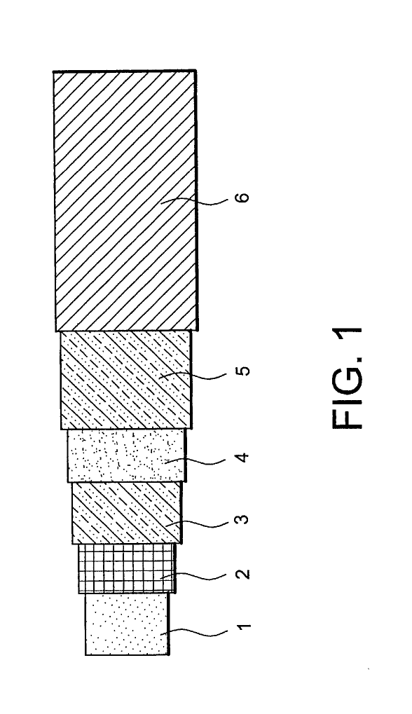

FIG. 1 shows such an arrangement of layers obtained by deposition of the different layers in a determined order.

Thus in the first step, a layer of porous material, for example graphite impregnated with a water repellent polymer, for example such as PVDF (polyvinylidene fluoride) is applied to a rigid cylindrical substrate 1. According to one particular embodiment of the invention, this substrate is made of a polymer material. In this case, the substrate may be obtained by extrusion of a polymer or a mix of polymers. The material making up the cylindrical substrate may for example be composed of a polypropylene/polyamide mix, the polyamide being eliminated in the final phase of the process by an acid solution, or it may be composed of a single polymer, for example such as polyalphamethylstyrene. It may also be made from a mineral material, for example such as sodium chloride that can be eliminated by washing with water.

The fundamental characteristic of the invention thus lies in the fact that at least one of the constituents of the organic or mineral material used in the composition of the substrate may be eliminated during a treatment at the end of the process, in order to obtain a porous substrate or an empty space (depending on whether elimination is partial or total). For example, it will be possible to envisage a mix of polymers or mineral compounds comprising at least one soluble component, for example in an acid aqueous solution or in an organic solvent, in order to thus eliminate this component by a washing phase, or a thermally metastable component that can then be eliminated in a heating phase. The porous space or the empty space obtained can be used to supply the electrode with reagent, since the electrode is directly in contact with the cylindrical substrate. For example, this porosity (in the case of partial elimination) may be between 40 and 60% and it contributes to forming cavities or spaces between ducts, thus facilitating the circulation of fuel.

The layer of porous material, for example made of graphite, forms the first part of the electrode called the diffusion layer. This layer diffuses reagents towards the active part of the electrode, in addition to performing mechanical support functions for the electrode and carrying the current. This layer is deposited using conventional techniques for creating thin layers, such as graphite sputtering in the liquid phase or dipping.

This layer of porous material preferably has a high electric conductivity, of the order of 50 S/cm, a porosity of the order of 70% and perfect control of hydrophilicity and roughness. Hydrophilicity in the invention is related to the presence of a water repellent binder in the formulation of the graphite. For example, this binder may be a derivative of Teflon® or PVDF (polyvinylidene fluoride) and may, for example, be present at a proportion of 2 to 8% of the mass of the porous material forming the diffusion layer. The roughness is directly related to the size of the particles in the porous material, for example graphite, this dimension being for example of the order of 2 to 40 μm diameter. The particular structure of this porous layer must also enable deposition of the catalyst without any major difficulty (to form the active layer), and particularly so that a thin homogeneous ionic conducting layer impermeable to gas can be formed on top, for example of the order of 5 to 20 μm thick, this thin layer forming the membrane of the assembly.

Electrons have to be collected from one end of the cylinder to the other using a current collector to achieve good conductivity of the fuel cell, particularly when the porous diffusion layer and the active layer are not sufficiently conducting. According to FIG. 1, the current collector 2 may for example be made in the form of a metallic deposit using conventional vacuum deposition methods such as PVD (“Physical Vapor Deposition”) or CVD (“Chemical Vapor Deposition), this deposition preferably being made in a spiral in order to scan the entire length of the cylinder.

According to one variant of the invention, the metal deposition may be substituted by winding metallic micro-filaments around the cylinder. These filaments may also be used to stabilize the complete structure, in other words the association of all electrode-membrane-electrode assemblies to form a miniature fuel cell adapted to portable equipment.

It would also be possible to consider using a mesh of metallic fabric. The wires used both for winding and for manufacturing the metallic fabric may for example be made of stainless steel, gold or platinum.

The catalyst is deposited on the layer of porous material defining the diffusion layer, for example in the form of grains of noble metal, for example such as grains of platinum, making use of conventional techniques, in other words dipping or sputtering of an active ink. Obviously, catalyst deposition techniques by electrochemical or chemical reduction of a catalyst salt could be considered. This catalyst layer forms the active layer in which the electrochemical reaction takes place. The current collector-diffusion layer-active layer assembly forms an electrode. As shown in FIG. 1, layers 2, 3 represent the anode of the electrode-membrane-electrode assembly (in other words an anode composed of a current collector, a diffusion layer and an active layer), that will be supplied with fuel through substrate 1 that has become porous or transformed into an empty space at the end of the process. A thin film is usually deposited on the active surface, made of a conducting polymer, for example a protonic polymer with a structure identical to the structure of the membrane in order to facilitate ionic transport, such as the transport of H+ions in the case of a PEMFC cell.

A thin conducting membrane 4, for example a protonic membrane, is then deposited on the surface of the cylinder using conventional techniques, for example such as sputtering or dipping. Deposition may also be envisaged by sublimation of organic precursors, for example such as sublimation of diamines and dianhydrides, to form polyimides. All ionic conducting polymers or polymers that could become ionic and conducting by a treatment, for example using soluble sulphonation agents, are suitable for this architecture.

For example, the polymer forming the membrane can be chosen among fluorided polymers or sulphoned perfluorided polymers, sulphoned polyimides, sulphoned polyethersulfones, sulphoned polystyrenes and their sulphoned derivatives, sulphoned polyethercetones and their sulphoned derivatives, sulphoned polybenzoaxoles, sulphoned polybenzimidazoles and their sulphoned derivatives, sulphones polyarylenes such as paraphenylenes and sulphoned polyparaxylylenes and their sulphoned derivatives.

A new layer of porous material 5, for example such as graphite impregnated with a catalyst (thus forming the diffusion layer and the active layer of the other electrode) is then deposited on the membrane to form the peripheral electrode with the current collector 6 that will form the cathode 5, 6 of the assembly according to this particular embodiment of the invention. The current collector 6 at the cathode is again made by metallic deposition, for example in spiral or by winding metallic micro-filaments or a mesh of a metallic fabric.

After these operations have been carried out, the electrode-membrane-electrode assembly obtained is treated chemically or thermally to eliminate at least one component of the material used for composition of the cylindrical support.

This treatment may be used firstly as a treatment to obtain a porous cylindrical substrate, and as a treatment to prepare the membrane to be transported, particularly, H+protons for PEMFC cells from the anode to the cathode. At the end of the process, the result is electrode-membrane-electrode assemblies in the form of small diameter tubes (of the order of one millimeter), these tubes forming the basic elements or the cores of cells used in the composition of fuel cells.

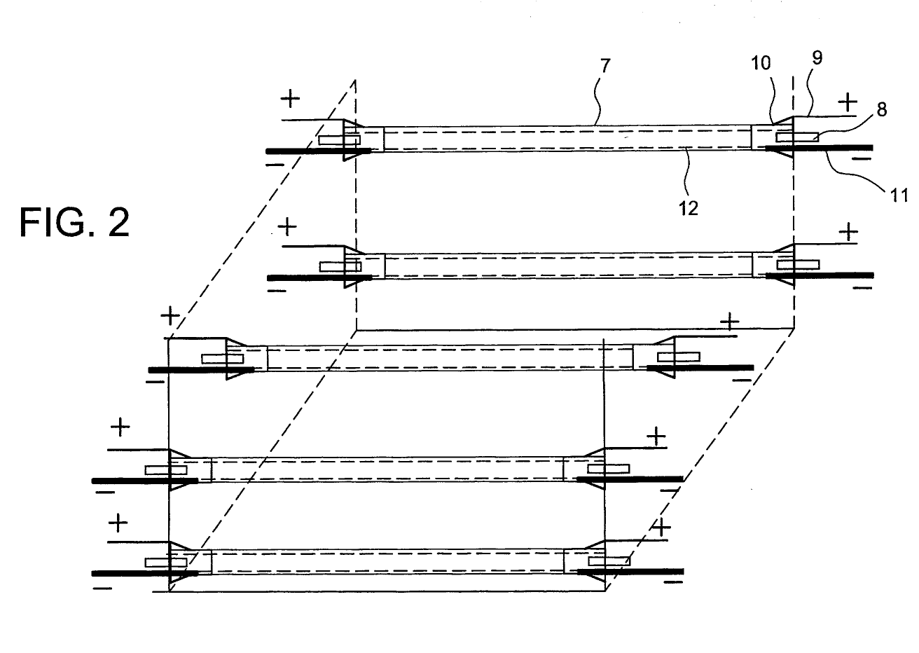

FIG. 2 shows such a fuel cell composed of several electrode-membrane-electrode assemblies mounted in series, the electrical connections used to make this assembly being made, for example, by metallic filaments output from the different current collectors. The assembly 7 is connected to the walls of the cell through the supports 8. Conducting wires 9 are in contact with the outside face 10 of the electrode-membrane-electrode assembly 7, this face corresponding to the cathode. This contact is set up at each end of the electrode-membrane-electrode assembly 7. Similarly, conducting wires 11 are in contact with the inside face 12 of the electrode-membrane-electrode assembly 7, this face corresponding to the anode. These electrical contacts are made at each electrode-membrane-electrode assembly used in the composition of the fuel cell. These contacts will obviously be used for the circulation of electrical energy created in the assemblies. The fuel, such as hydrogen for PEMFC cells or methanol for DMFC cells, circulates in the core of the electrode-membrane-electrode assembly, within the space left free by treatment of the cylindrical substrate, in order to be in contact with the anode, while the oxidant such as oxygen circulates between the different basic elements and is in contact with the cathodes.

This invention is equally applicable to fuel cell systems operating with a hydrogen/oxygen mix for PEMFC cells and with a methanol/oxygen mix for DMFC cells. The invention is also equally applicable to medium power fuel cells and low power fuel cells. However, the process is particularly suitable for the manufacture of micro fuel cell systems for applications for portable energy micro-sources.

With the process described above, due to the manufacture of 0.5 to 1 mm diameter micro-tubes, it is possible to envisage architectures with a volume close to 7.5 cm3, within which the active surface area is between 130 and 250 cm².

### EXAMPLE EMBODIMENT OF AN ELECTRODE-MEMBRANE-ELECTRODE ASSEMBLY ACCORDING TO THE INVENTION

In a first step, the cylindrical substrate is obtained by extrusion of a 50-50 mix of polypropylene and a polyamide at 200° C., to obtain a tube diameter equal to about 500 μm.

A metallic current collector is deposited on the newly formed cylindrical substrate by a PVD (“Physical Vapor Deposition”) method starting from a platinum target. The deposit obtained is a thin layer with a thickness of 5000 Å.

The next step is to deposit the diffusion layer by dipping in a formulation of graphite (95% dry material), PVDF (5% dry material) and solvent such as THF, the dry material corresponding to 20% of the total material. The assembly is dried for one hour at 70° C.

An active ink is sputtered onto the diffusion layer, based on platinized carbon and Nafion®, with a platinum content equal to 0.2 mg/cm² and a platinum/Nafion® ratio equal to 1. The result is the active layer.

The membrane is deposited by dipping in a 15% solution Nafion®, and the assembly is put in the drying oven for 3 hours at 100° C.

The next step is deposition of the other electrode in the same way as for the first electrode, namely by deposition of the diffusion layer, the active layer and the current collector.

Once the deposition phases are complete, the assembly is treated in 10N sulphuric acid at 70° C. to dissolve the polyamide making up the substrate and to make the membrane conducting.

Obviously, an expert in the subject could make various modifications to the process that has just been described as a non limitative example, without going outside the protection scope defined in the appended claims.

1. Process for making an electrode-membrane-electrode assembly on a cylindrical substrate, characterized in that the electrode-membrane-electrode assembly is made by successive deposition of an electrode layer, a membrane layer and an electrode layer around the said cylindrical substrate, the said substrate being composed of a material that can be totally or partially eliminated during an elimination step at the end of the said process.

2. Process for making an electrode-membrane-electrode assembly according to claim 1, characterized in that the cylindrical substrate is made from an organic material.

3. Process for making an electrode-membrane-electrode assembly according to claim 2, characterized in that the cylindrical substrate is obtained by extrusion of a polymer or a mix of polymers.

4. Process for making an electrode-membrane-electrode assembly according to claim 1, characterized in that the substrate is made from a mineral material.

5. Process for making an electrode-membrane-electrode assembly according to claim 1, characterized in that the said step to partially or totally eliminate the substrate is done using a chemical treatment or a heat treatment.

6. Process for making an electrode-membrane-electrode assembly according to claim 5, characterized in that the chemical treatment at the end of the process also treats the membrane in order to prepare it for ionic conduction.

7. Process for making an electrode-membrane-electrode assembly according to claim 1, characterized in that the deposition of the electrode layers includes the deposition of a diffusion layer, preferably by the deposition of a porous material, the said material preferably being impregnated with a water repellent polymer.

8. Process for making an electrode-membrane-electrode assembly according to claim 7, characterized in that the porous material partly forming the diffusion layer is made of graphite.

9. Process for making an electrode-membrane-electrode assembly according to claim 7 or 8, characterized in that the deposition of electrode layers includes the deposition of an active layer on the said diffusion layer made by deposition of a catalyst layer, preferably being in the form of noble metal grains.

10. Process for making an electrode-membrane-electrode assembly according to claim 9, characterized in that the noble metal used is platinum.

11. Process for making an electrode-membrane-electrode assembly according to claim 1, characterized in that the deposit of the membrane layer is made by deposition of a conducting polymer, for example protonic, or that could become a conducting polymer following an appropriate treatment.

12. Process for making an electrode-membrane-electrode assembly according to claim 1, characterized in that this process also comprises a step to make a current collector in each of the electrode layers.

13. Process for making an electrode-membrane-electrode assembly according to claim 12, characterized in that the current collector is made by metallic deposition, preferably in a spiral, at each of the electrode layers.

14. Process for making an electrode-membrane-electrode assembly according to claim 12, characterized in that the current collector is made by winding metallic micro-filaments at each of the electrode layers.

15. Process for making an electrode-membrane-electrode assembly according to claim 12, characterized in that the metallic deposit is made by a metallic fabric mesh at each of the electrode layers.

16. Electrode-membrane-electrode assembly that can be obtained by the process according to any one of the previous claims.

17. Fuel cell comprising at least one electrode-membrane-electrode assembly according to claim 16.
